(19) United States
(12) Patent Application Publication
(10) Pub. No.: US 2021/0299822 A1
(43) Pub. Date: Sep. 30, 2021

(54) CRYSTAL CENTERING AND CLAMPING DEVICE

(71) Applicant: Hunan Sanan Semiconductor Co., Ltd., Hunan (CN)

(72) Inventors: HONGTAI LIN, Hunan (CN); JIE ZHANG, Hunan (CN); WUQING LIN, Hunan (CN); SHUANGTU SU, Hunan (CN)

(21) Appl. No.: 17/212,721

(22) Filed: Mar. 25, 2021

(30) Foreign Application Priority Data
Mar. 30, 2020 (CN) 202010240166.6

(51) Int. Cl. B25B 5/16

(52) U.S. Cl. CPC B25B 5/16

(57) ABSTRACT

A crystal centering and clamping device has a first jig, a second jig, a clamping mechanism and an ejector mechanism. The first jig and the second jig are used for bonding on opposite end faces of a crystal, and positioning holes are arranged at the central positions of the first jig and the second jig. The ejector mechanism is located at one side of the clamping mechanism and can move towards or away from the clamping mechanism, so that the ejector mechanism can abut against the positioning hole of the first jig or the second jig above the crystal in the clamping mechanism.

### CROSS-REFERENCE TO RELATED APPLICATIONS

This application claims priority to Chinese Utility Patent Application No. 202010240166.6 entitled “CRYSTAL CENTERING AND CLAMPING DEVICE” filed before China's National Intellectual Property Administration on Mar. 30, 2020, the entire contents of each of which are incorporated herein by reference.

### STATEMENT RE: FEDERALLY SPONSORED RESEARCH/DEVELOPMENT

Not Applicable

### BACKGROUND

### 1. Technical Field

The present disclosure relates to the technical field of semiconductor material processing, in particular to a crystal centering and clamping device.

### 2. Related Art

The edge of a flaky or columnar crystal needs to be polished, so that the crystal can be modified into a circular shape.

In the prior art, two jigs can be used for fixing and bonding on opposite sides of the crystal at first, but because of manual alignment and bonding, the symmetry degree of the two jigs is low, that is, the axial coincidence degree of the two jigs is low, which easily leads to oval crystal bars in the processing process of the crystal, and is not easy for the next semiconductor processing.

### SUMMARY

In accordance with one embodiment, the purpose of the present disclosure is to provide a crystal centering and clamping device to alleviate the technical problem of poor symmetry between two jigs caused by manual bonding of jigs at both ends of a crystal in the prior art.

An embodiment of the present disclosure provides a crystal centering and clamping device, which comprises a first jig, a second jig, a clamping mechanism and an ejector mechanism, wherein the first jig and the second jig are used for adhering to opposite end faces of a crystal, and positioning holes are arranged at the central positions of the first jig and the second jig.

The ejector mechanism may be located at one side of the clamping mechanism and can move towards or away from the clamping mechanism, so that the ejector mechanism can abut against the positioning hole of the first jig or the second jig above the crystal in the clamping mechanism.

Furthermore, the clamping mechanism may comprise a base and a plurality of clamping jaws, wherein the clamping jaws are arranged around the same center of a circle and are connected to the base in a sliding way; the distance between the clamping jaws and the center of the circle is adjustable; and the clamping jaws have the same motion state, so that the distances between the clamping jaws and the center of the circle are equal.

Further, the crystal centering and clamping device may comprise a support rod which is connected with the base, and the ejector mechanism is slidably connected with the support rod, so that the distance between the ejector mechanism and the clamping mechanism can be adjusted.

Furthermore, a locking mechanism may be arranged between the ejector mechanism and the supporting rod, and the ejector mechanism is fixed with the supporting rod after being locked by the locking mechanism.

Furthermore, the base may be in sliding connection with the support rod, so that the distance between the base and the thimble mechanism can be adjusted.

Further, the base may be rotatably connected with the support rod, so that the base can rotate around the support rod.

Furthermore, a locking mechanism may be arranged between the base and the supporting rod, and after the locking mechanism is locked, the base and the supporting rod are relatively fixed.

Furthermore, one side of the first jig and the second jig may both be provided with a boss for holding.

Furthermore, the jaws may be stepped, and the radial difference between two adjacent steps of the jaws may be equal to the radial difference between the first jig and the boss, so that a plurality of jaws can simultaneously clamp the edge of the first jig and the edge of the boss on the first jig.

Furthermore, the number of the clamping jaws may be three, and every two of the three clamping jaws form a circular angle of 120 degrees.

The embodiments of the present disclosure provide a crystal centering and clamping device, which comprises a first jig, a second jig, a clamping mechanism and an ejector mechanism, wherein the first jig and the second jig are used for adhering to opposite end faces of a crystal, and positioning holes are arranged at the central positions of the first jig and the second jig. The clamping mechanism may be used for clamping the crystal and the first jig, and the ejector pin mechanism may be located at one side of the clamping mechanism and can move towards or away from the clamping mechanism. The use method and principle of the crystal centering clamping device are as follows: release the clamping mechanism, put the crystal to be centered into the clamping mechanism, and clamp and fix it with the clamping mechanism. Coat adhesive on one side of that first jig, bonding the side coat with adhesive on the crystal, adjusting the position of the first jig and moving the ejector mechanism toward one side of the first jig, so that the ejector mechanism is inserted into the central position hole of the first jig. After the first jig and crystal are completely bonded, keep the ejector mechanism away from the first jig, take out the crystal and the first jig at the same time, turn them over, put them into the clamping mechanism with the crystal facing up and the first jig facing down, and lift the first jig slightly so that the clamping mechanism clamps the edge of the first jig and the crystal height exceeds the clamping mechanism. After coating the second jig with adhesive medium, contact the crystal with the adhesive surface, adjust the position of the second jig on the crystal, and press the ejector mechanism down to the positioning hole in the center of the second jig. After cooling with adhesive medium, the first jig and the second jig will be symmetrically fixed on both sides of the crystal.

### BRIEF DESCRIPTION OF THE DRAWINGS

In order to explain the specific embodiment of the present disclosure or the technical scheme in the prior art more clearly, the drawings used in the description of the specific embodiment or the prior art will be briefly introduced below. The drawings in the following description are some embodiments of the present invention, and other embodiments may be derived by those having ordinary skill in the art.

FIG. 1 is a schematic diagram of a first jig of a crystal centering and clamping device provided by an embodiment of the present disclosure;

FIG. 2 is a schematic diagram of a second jig of a crystal centering and clamping device provided by an embodiment of the present disclosure;

FIG. 3 is a schematic diagram of a crystal centering and clamping device provided by an embodiment of the present disclosure;

FIG. 4 is a schematic diagram of the first step when the crystal centering and clamping device provided by the embodiment of the present disclosure is used;

FIG. 5 is a schematic diagram of the second step when the crystal centering and clamping device provided by the embodiment of the present disclosure is used;

FIG. 6 is a schematic diagram of the third step when the crystal centering and clamping device provided by the embodiment of the present disclosure is used.

Reference Numbers: 100—the first jig; 200—second jig; 310—gripper; 320—base; 400—ejector mechanism; 510—First rocker; 520—second rocker; 600—support rod; 710—boss; 720—locating hole; 800—crystal.

### DETAILED DESCRIPTION

In the following, the technical scheme of the present disclosure will be described with examples. The described examples are part of the embodiments of the present disclosure, not all of them. Based on the embodiments of the present disclosure, all other embodiments with the purview of those having ordinary skill in the art are deemed to be within the scope of the present disclosure.

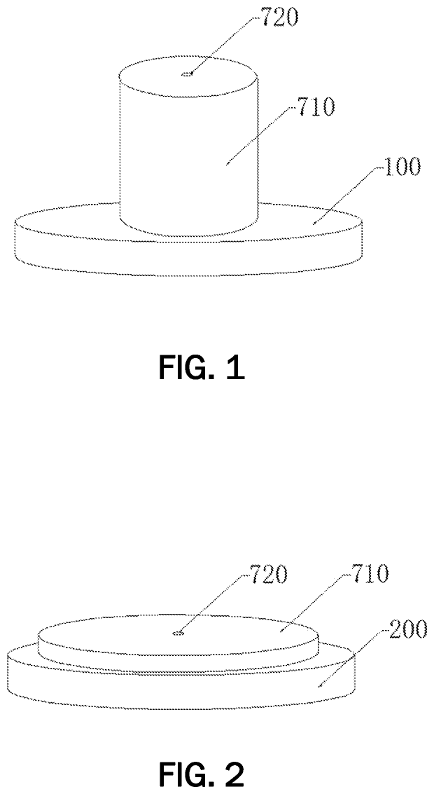

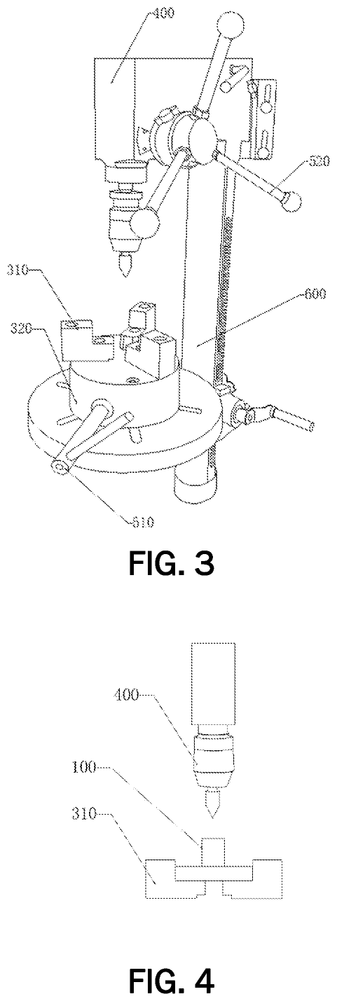

As shown in FIG. 1-FIG. 6, a crystal centering and clamping device provided by an embodiment of the present disclosure includes a first jig 100, a second jig 200, a clamping mechanism and an ejector mechanism 400, wherein the first jig 100 and the second jig 200 are used for adhering to opposite end faces of a crystal 800, and a positioning hole 720 is arranged at the center of the first jig 100 and the second jig 200; The clamping mechanism is used for clamping the crystal 800 and the first jig 100, and the ejector pin mechanism 400 is located at one side of the clamping mechanism and can move towards or away from the clamping mechanism. The use method and principle of the crystal centering clamping device are as follows: release the clamping mechanism, put the crystal 800 to be centered into the clamping mechanism, and clamp and fix it with the clamping mechanism. Coating adhesive on one side of the first jig 100, bonding the side coated with adhesive to the crystal 800, adjusting the position of the first jig 100 and moving the ejector mechanism 400 toward the first jig 100 side, so that the ejector mechanism 400 is inserted into the central positioning hole 720 of the first jig 100. After the first jig 100 and the crystal 800 are completely bonded, the ejector mechanism 400 is far away from the first jig 100, the crystal 800 and the first jig 100 are taken out and turned over at the same time, and put into the clamping mechanism with the crystal 800 facing up and the first jig 100 facing down, and the first jig 100 is slightly lifted so that the clamping mechanism clamps the edge of the first jig 100 and the crystal height exceeds the clamping mechanism. After coating the second jig 200 with adhesive medium, contact the crystal with the adhesive surface, adjust the position of the second jig 200 on the crystal, and press the ejector mechanism 400 down to the positioning hole 720 in the center of the second jig 200. After cooling with adhesive medium, the first jig 100 and the second jig will be symmetrically fixed on both sides of the crystal.

The clamping mechanism comprises a base 320 and a plurality of clamping jaws 310, wherein the clamping jaws 310 are arranged around the same center; the clamping jaws 310 are slidably connected to the base 320; the distance between the clamping jaws 310 and the center is adjustable; and the clamping jaws 310 have the same motion state, so that the distances between the clamping jaws 310 and the center are equal.

The clamping mechanism specifically comprises a base 320 and a plurality of clamping jaws 310, and the plurality of clamping jaws 310 can gather or scatter in the same motion state to ensure that the middle parts of the clamping jaws 310 can contact the middle crystal at the same time. The base 320 is provided with a first rocker 510, which can control the jaw 310 to move toward or away from the center of the circle by rotating the first rocker 510 forward or backward. The jaw 310 is connected with the first rocker 510 through a transmission mechanism, which can include conventional mechanical elements such as racks and gears. In this embodiment, the number of the clamping jaws 310 is three, and the three clamping jaws 310 form a circular angle of 120 degrees every two, and a plane can be determined by three points.

The crystal centering and clamping device comprises a supporting rod 600 which is connected with the base 320, and the ejector mechanism 400 is slidably connected with the supporting rod 600, so that the distance between the ejector mechanism 400 and the clamping mechanism can be adjusted.

The ejector mechanism 400 can be integrated with the clamping mechanism through the supporting rod 600, which is perpendicular to the clamping mechanism and can move up and down on the supporting rod 600. Specifically, the supporting rod 600 is provided with a yo-rack, and the ejector mechanism 400 is provided with a second rocker 520 which is connected with a gear which meshes with the rack on the supporting rod 600.

A locking mechanism is arranged between the ejector mechanism 400 and the support rod 600. After the locking mechanism is locked, the ejector mechanism 400 is fixed with the support rod 600.

When the crystal is bonded to the first jig 100 or the second jig 200, the ejector mechanism 400 can play a fixing role. Taking the first jig 100 as an example, the first jig 100 is coated with adhesive medium and placed on the end face of the crystal. When the ejector mechanism 400 descends until its tip is inserted into the positioning hole 720 of the first jig 100, the ejector mechanism 400 can be locked, and the ejector mechanism 400 cannot move up and down, which can limit the first jig 100 during the cooling of the adhesive medium to prevent the first jig 100 from shifting relative to the crystal. Similarly, when the second jig 200 is bonded to the crystal, the ejector mechanism 400 can be locked by the locking mechanism to prevent the position of the second jig 200 from changing during bonding.

The base 320 is slidably connected with the support rod 600, so that the distance between the base 320 and the thimble mechanism 400 can be adjusted. The base 320 is rotatably connected with the support rod 600, so that the base 320 can rotate around the support rod 600.

Before the crystal is bonded to the first jig 100 and the second jig 200, the clamping mechanism and the ejector mechanism 400 can be corrected so that the ejector mechanism 400 points to the center of the clamping mechanism, which is the center of a plurality of jaws 310 in this embodiment. The first jig 100 can be placed in the clamping mechanism first, and the thimble can be inserted into the positioning hole 720 of the first jig 100 by rotating or lifting the clamping mechanism. After the first jig 100 is removed, the position pointed by the tip of the thimble mechanism 400 is the center of the clamping mechanism. When the crystal is clamped by the clamping mechanism, the center of the crystal is aligned with the tip of the thimble mechanism 400. Specifically, the connection between the base and the support rod can also be a rack and a gear, so as to achieve the purpose of lifting and rotating.

In order to avoid relative movement between the corrected clamping mechanism and the supporting rod 600, a locking mechanism is arranged between the base 320 and the supporting rod 600, and after the locking mechanism is locked, the base 320 and the supporting rod 600 are relatively fixed. The locking mechanism may include a screw abutting against the support rod 600, and the locking screw may abut against the support rod 600 by rotating the screw, thereby achieving the purpose of locking.

A boss 710 is provided on one side of the first jig 100 and the second jig 200, and the boss 710 is used for holding. The first jig 100 and the second jig 200 need to be heated before the adhesive medium is applied, so it is convenient to hold the first jig 100 and the second jig 200 with tools by setting the boss 710 structure.

The clamping jaw 310 is stepped, and the radial difference between two adjacent steps of the clamping jaw is equal to the radial difference between the first jig and the boss, so that a plurality of clamping jaws can simultaneously clamp the edge of the first jig and the edge of the boss on the first jig, and the stepped shape of the clamping jaw 310 corresponds to the shape of the first jig 100. After the first jig 100 is bonded to the crystal, the crystal and the first jig 100 need to be turned over. At this time, the stepped structure on the plurality of jaws 310 can support the second jig 200. At the same time, when the jaws 310 gather together, the plurality of jaws 310 can clamp the first jig 100 and its boss, and the stress is more stable.

To sum up, the specific process steps of the device provided by the embodiment of the present disclosure are as follows:

Step 1: as shown in FIG. 4, the first jig 100 is placed in the center of the clamping mechanism, and the first rocker 510 on the base 320 is continuously rotated so that the jaws 310 are continuously retracted inward until the first jig 100 contacts the jaws 310 and the first jig 100 cannot move or rotate; Then release the locking mechanism so that the base 320 can rotate left and right to adjust its position, and rotate the second rocker 520 on the right side of the ejector mechanism 400 to let the ejector mechanism 400 extend downward, so that the ejector mechanism 400 can fix the positioning hole 720 in the center of the first jig 100. If not, adjust the left and right directions or height of the base 320 respectively. After the calibration is completed, lock the base and support rod, and the calibration is completed.

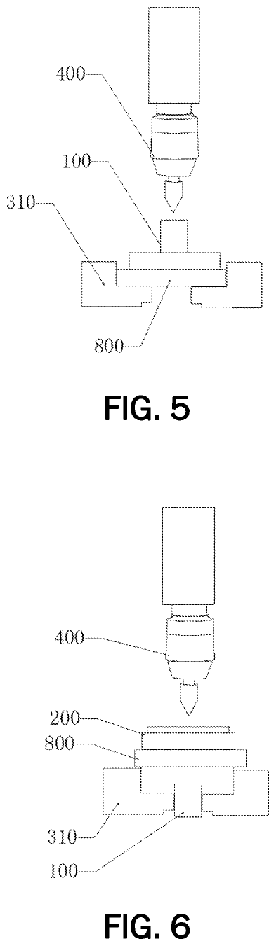

Step 2: as shown in FIG. 5, loosen the clamping mechanism, take out the first jig 100, put the crystal to be centered into the clamping mechanism, and continuously rotate the first rocker 510 on the base 320, so that the clamping jaw 310 is continuously retracted inward until the crystal slightly contacts the clamping mechanism and cannot move and rotate; After heating the first jig 100, the adhesive is coated on the largest surface of the first jig 100, and the surface coated with the adhesive is bonded to the crystal. At the same time, the ejector mechanism 400 is pressed down so that the ejector mechanism 400 can fix the positioning hole 720 in the center of the first jig 100, and the second rocker 520 on the left side of the ejector mechanism 400 is rotated to fix the position of the ejector mechanism 400.

Step 3: as shown in FIG. 6, after the first jig 100 and the bonding medium are cooled down, release the ejector mechanism 400, take out the crystal and the first jig 100, turn it over, put it into the clamping mechanism with the crystal facing up and the first jig 100 facing down, lift the jig slightly so that the crystal exceeds the height of the clamping mechanism by 1-2 cm, and continuously rotate the first rocker 510 on the base 320 so that the clamping jaw 310 keeps inward. Heating the second jig 200, coating adhesive medium on the largest surface, contacting the crystal with the adhesive surface, then pressing the ejector mechanism 400 down to the positioning hole 720 in the center of the second jig 200 to fix the ejector mechanism 400. After the second jig 200 cools, the first jig 100 and the second jig 200 at both ends will be symmetrically fixed on both sides of the crystal in the center of the crystal.

According to the method, a manual centering bonding mode is not needed, so that rework bonding and deviation of processing positions caused by unreasonable bonding of jigs on both sides due to no centering bonding of crystals are avoided. If the crystal is not centered, the bonding position on both sides is asymmetric, and it cannot be installed on the machine during rounding processing. Even if it is installed, the unreasonable determination of the center position leads to excessive crystal processing times and excessive consumption of raw materials.

Finally, it should be noted that the above embodiments are only used to illustrate the technical scheme of the present disclosure, but not to limit it. Although the present disclosure has been described in detail with reference to the foregoing embodiments, those of ordinary skill in the art should understand that the technical solutions described in the foregoing embodiments can still be modified, or some or all of the technical features can be equivalently replaced; However, these modifications or substitutions do not make the essence of the corresponding technical solutions deviate from the scope of the technical solutions of each embodiment of the present disclosure.

What is claimed is:

1. A crystal centering and clamping device comprising:
a first jig bonding on a first face of a crystal;
a second jig bonding on a second face of the crystal opposite the first face;
a clamping mechanism; and
an ejector mechanism located at one side of the clamping mechanism, the ejector mechanism being movable towards and away from the clamping mechanism with the ejector mechanism contacting the first jig or the second jig above the crystal in the clamping mechanism.

2. The crystal centering and clamping device of claim 1, wherein the clamping mechanism comprises a base and a plurality of clamping jaws, the clamping jaws being arranged around a center, and are slidably connected to the base extending to the center of a circle.

3. The crystal centering and clamping device of claim 2, wherein the crystal centering and clamping device comprises a support rod connected with the base, and the ejector mechanism being slidably connected to the support rod with the ejector mechanism being connected to the base.

4. The crystal centering and clamping device of claim 3, further comprising a locking mechanism disposed between the ejector mechanism and the supporting rod (600), wherein with the locking mechanism being locked, the ejector mechanism is fixed with the supporting rod.

5. The crystal centering and clamping device of claim 3, wherein the base is slidably connected with the support rod and the distance between the base and the ejector mechanism being adjustable.

6. The crystal centering and clamping device of claim 3, wherein the base is rotatably connected with the support rod and the base being rotatable around the support rod.

7. The crystal centering and clamping device of claim 6, further comprising a locking mechanism arranged between the base and the supporting rod, with the locking mechanism being locked, the base and the supporting rod being fixed.

8. The crystal centering and clamping device of claim 2, further comprising a boss arranged on one side of the first jig and the second jig.

9. The crystal centering clamping device of claim 8, wherein the clamping jaw is stepped, and the radial difference between two adjacent steps of the clamping jaw is equal to the radial difference between the first jig and the boss, a plurality of the clamping jaws simultaneously clamping the edge of the first jig and the edge of the boss on the first jig.

10. The crystal centering and clamping device of claim 2, wherein a number of the clamping jaws is three, and the three clamping jaws form a circular angle of 120 degrees for every two.
